(19) United States
(12) Patent Application Publication
(10) Pub. No.: US 2005/0085596 A1
(43) Pub. Date: Apr. 21, 2005

(54) Curable resin composition

(75) Inventor: Hiroyuki Okuhira, Kanagawa (JP)

Correspondence Address: Finnegan, Henderson, Farabow,;Garrett & Dunner, L.L.P., 1300 I Street, N.W., Washington, DC, 20005-3315, US

(73) Assignee: THE YOKOHAMA RUBBER CO., LTD.

(21) Appl. No.: 10/963,633

(22) Filed: Oct. 14, 2004

(30) Foreign Application Priority Data
Oct. 17, 2003 (JP) 2003-358360

(51) Int. Cl. C08L 75/04; C08G 12/00

(52) U.S. Cl. 525/453; 528/44; 528/85; 528/229

(57) ABSTRACT

A curable resin composition containing an isocyanate compound (A) and aromatic ketimine (B) obtained by reacting aromatic amine having an amino group directly bound to an aromatic ring with cyclic ketone, in which storage stability and curability are compatible when the composition is used as a one-liquid type and a working life is appropriately long and working property is excellent because no thickening is caused by mixture of two liquids when the composition is used as a two-liquid type.

This application claims priority on Japanese patent application No.2003-358360, the entire contents of which are hereby incorporated by reference. In addition, the entire contents of literatures cited in this specification are incorporated by reference.

### BACKGROUND OF THE INVENTION

The present invention relates to a curable resin composition which is excellent in working property as an adhesive agent etc in the fields of painting compounds, civil engineering, and construction, and also favorable in curability and storage stability.

An isocyanate compound forms a three dimensional crosslinking structure by reacting with a curing agent such as amine to become a polyurethane cured compound which has high strength and high elongation, and which is excellent in abrasion resistance, lipid resistance, and the like. Thus, conventionally the isocyanate compound has been widely used as joint fillers, sealants, and adhesive agents. Storage of the isocyanate compound in a mixed state with amine poses a problem in that a curing reaction progresses during storage to result in poor storage stability. Thus, typically, the isocyanate compound and the curing agent are used as a so-called two-liquid type where a base material and a curing agent are mixed at a work operation. However, recently, development of an isocyanate type curable resin composition which can be used as a one-liquid type where a base material and a curing agent are precedently mixed has been desired because the composition does not require mixing/conditioning of a composition at a field erection work and the composition can be easily handled.

As a technique for use in the one-liquid type, it is known that if active hydrogen of a curing agent used is chemically blocked to make the curing agent moisture-curable, the curing agent can be filled with a base material (isocyanate compound) in the same container, and they are stored and used in one liquid.

As a skill for chemically blocking the active hydrogen of the curing agent, ketimine where amine is blocked with ketone is known. In general, ketimine synthesized from alkylenediamine and ketone such as methyl isobutyl ketone or methyl ethyl ketone is known. Ketimine is stable in the absence of water, but in the presence of water, it is easily hydrolyzed to become an active amine. Thus, ketimine is hydrolyzed with moisture in air to produce an active amine and act as a curing agent.

However, a one-liquid type mixture using the aforementioned commonly used ketimine conventionally known publicly as a potential curing agent of the isocyanate compound poses a problem in that sufficient storage stability is not obtained because, for example, gelation progresses at the storage.

Meanwhile, such a blocking skill is also known as a method of prolonging a working life to make working property favorable in an isocyanate type curable resin composition of two-liquid type.

For example, JP 2003-048938 A proposes a curing agent composition containing ketimine formed by reacting (A) 10 to 70 mol % of amino groups of trialkylbenzenediamine represented by a given general formula with (B) ketone.

JP 2003-113217 A proposes a two-liquid curing type polyurethane composition containing: a curing agent, which is mainly composed of an active hydrogen compound (a), obtained by dehydrating/condensing trialkylbenzenediamine represented by a given general formula and aliphatic ketone or aliphatic aldehyde represented by a given general formula such that a ketimine formation rate ranges from 20 to 80%; a base material which is mainly composed of organic polyisocyanate or polyisocyanate component (b) obtained by a reaction of organic polyisocyanate with polyol; and a curable catalyst (c) which is at least one of organic acids or inorganic acids.

However, any of the above compositions has a ketimine formation rate of less than 95%. Thus, active amine is present in the curing agent, and the amine and isocyanate groups (hereinafter also simply referred to as “NCO group”) react to be increased the viscosity of the composition in parallel with mixture of the base material and the curing agent. Therefore, there has been a problem in that the working property is poor at the time of mixture of the two-liquid type curable resin composition. Also likewise, the one-liquid type curable resin composition where the base material and the curing agent are precedently mixed is increased the viscosity of the composition during the storage, and thus could not be used as the one-liquid type curable resin composition. Furthermore, when the storage stability as the one-liquid type is retained by making the ketimine formation rate 100% using aliphatic ketone, hydrolysis property of ketimine at the use is extremely low, and it takes a long time to produce active amine. Therefore, there has been a problem in that a curing time of a polyisocyanate component becomes very long.

### SUMMARY OF THE INVENTION

Thus, an object of the present invention is to provide a curable resin composition using an isocyanate compound where storage stability and curability are compatible when the composition is used as a one-liquid type, and a working life is appropriately long and working property is excellent because no increase of the viscosity is caused by mixture of two liquids when the composition is used as a two-liquid type.

### DETAILED DESCRIPTION OF THE PREFERRED EMBODIMENTS

As a result of an intensive study for achieving the above object, the inventors of the present invention have found that in an isocyanate type curable resin composition containing aromatic ketimine where a ketimine formation rate is substantially 95% or more and preferably 100%, obtained by the use of cyclic ketone, storage stability and curability are compatible when the composition is used as a one-liquid type and a working life is appropriately long and working property is excellent because no increase of the viscocity is caused by mixture of two liquids when the composition is used as a two-liquid type. Thus, they have completed the present invention. That is, the present invention provides the curable resin compositions described in the following (1) to (9).

(1) A curable resin composition, containing an isocyanate compound (A) and aromatic ketimine (B) obtained by reacting aromatic amine having an amino group directly bound to an aromatic ring with cyclic ketone.

(2) The curable resin composition according to (1) in which the isocyanate compound (A) is a urethane prepolymer obtained by reacting a diisocyanate compound where all isocyanate groups in a molecule are bound to aliphatic or alicyclic secondary carbon or tertiary carbon with a polyol compound.

(3) The curable resin composition according to (1) in which the cyclic ketone which is reacted with the aromatic amine is ketone where carbon of a carbonyl group is a member of a ring.

(4) The curable resin composition according to (1) or (3) in which the aromatic amine is a trialkylbenzenediamine derivative represented by the following general formula (1).

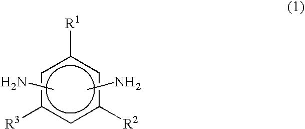

In the formula, R¹, R², and R³ each represent an alkyl group with 1 to 4 carbon atoms which may be branched, each of the alkyl groups may contain an oxygen atom or sulfur atom, and R¹, R², and R³ may be identical to or different from one another.

(5) The curable resin composition according to (1) or (3) in which a ketimine formation rate of the aromatic amine is 95% or more.

(6) The curable resin composition according to (1) or (3) in which the aromatic ketimine (B) is obtained by a reaction of 3,5-diethyl-2,6-diaminotoluene with cyclohexanone or cyclopentanone, a reaction of 3,5-diethyl-2,6-diaminotoluene with methylcyclohexanone or a reaction of 3,5-dimethylthio-2,6-diaminotoluene with cyclohexanone or cyclopentanone.

(7) The curable resin composition according to (1) or (3) in which a mix ratio of the aromatic ketimine (B) and the isocyanate compound (A) ranges from 0.01 to 1.5 at an equivalent ratio represented by [NCO groups in the isocyanate compound (A)]/[ketimine bonds (C═N) in the aromatic ketimine (B)].

(8) The curable resin composition according to (1) or (3), further containing an acid catalyst (C).

(9) The curable resin composition according to (1) or (3) in which the acid catalyst (C) is an acidic phosphate or a block acidic phosphate.

Hereinafter, the present invention is described in detail.

The curable resin composition of the present invention is a curable resin composition containing an isocyanate compound (A) and aromatic ketimine (B) having a ketimine bond (C═N) obtained by reacting aromatic amine having an amino group directly bound to an aromatic ring with cyclic ketone, and preferably further contains an acid catalyst (C).

Next, the isocyanate compound (A) and aromatic ketimine (B) used for the curable resin composition of the present invention are described in detail.

Isocyanate Compound (A)

The isocyanate compound (A) used in the curable resin composition of the present invention is not particularly limited as long as it is a compound having two or more NCO groups in the molecule. Specific examples thereof include: diisocyanate compounds such as aromatic polyisocyanates (including 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylylene diisocyanate (TMXDI), tolidine diisocyanate (TODI), and 1,5-naphthalene diisocyanate (NDI)), aliphatic polyisocyanates (including hexamethylene diisocyanate (HDI), trimethylhexamethylene diisocyanate (TMHDI), lysine diisocyanate, and norbornane diisocyanate methyl (NBDI)), and cycloaliphatic polyisocyanates (including transcyclohexane-1,4-diisocyanate, isophorone diisocyanate (IPDI), H₆XDI (hydrogenated XDI), H₁₂MDI (hydrogenated MDI), and H₆TDI (hydrogenated TDI); polyisocyanate compounds such as polymethylene polyphenylene polyisocyanate; carbodiimide modified polyisocyanates of those isocyanate compounds; isocyanurate modified polyisocyanates of those isocyanate compounds; and urethane prepolymers obtained by reacting those isocyanate compounds with the following polyol compounds. They may be used singly or as a mixture of two or more thereof. TMXDI, IPDI, and the like are particularly preferable.

It is also possible to use a monoisocyanate compound having only one NCO group in a molecule by mixing with a diisocyanate compound and the like.

In the present invention, it is preferred that the isocyanate compound (A) be a urethane prepolymer obtained by reacting a diisocyanate compound where all NCO groups in the molecule are bound to aliphatic or alicyclic secondary carbon or tertiary carbon as represented by the following general formula (2), with a polyol compound.

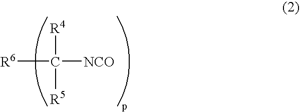

In the formula, p represents an integer of 2 or more, R⁴, R⁵, and R⁶ each independently represent an organic group which may contain at least one hetero atom selected from the group consisting of an oxygen atom, a nitrogen atom, and a sulfur atom, and R⁵ may be a hydrogen atom. Also, multiple R⁴ and R⁵ may be identical to or different from each other. Furthermore, when R⁵ is a hydrogen atom, parts of R⁴ and R⁶ may be bound to form a ring.

Examples of the organic group include organic groups containing: hydrocarbon groups such as alkyl groups with 1 to 8 carbon atoms, cycloalkyl groups with 6 to 20 carbon atoms, aryl groups with 6 to 20 carbon atoms, and alkylaryl groups groups with 6 to 20 carbon atoms; groups each having at least one hetero atom selected from the group consisting of O, S, and N (e.g., an ether, carbonyl, amide, or urea group (carbamide group), urethane bond, and the like). Of those, the organic groups represented by R⁴ and R⁵ are preferably alkyl groups, and particularly preferably methyl groups.

The urethane prepolymer obtained by reacting the diisocyanate compound with the polyol compound is a reaction product obtained by reacting the excessive diisocyanate compound (i.e., excessive isocyanate groups against hydroxyl groups) with the polyol compound, and generally contains 0.2 to 10%, preferably 0.5 to 5% by mass of isocyanate groups at a molecular end.

The diisocyanate compound which produces such a urethane prepolymer is not particular limited so long as the urethane prepolymer of a structure represented by the general formula (2) is obtained, and it is possible to use those used for manufacture of the polyurethane resin composition of one-liquid type known publicly. Specifically, the use of TMXDI, IPDI, hydrogenated MDI, or hydrogenated TDI in the above mentioned diisocyanate compounds is preferable because stability of the resultant urethane prepolymer and the aromatic ketimine (B) in a mixed state is high and reactivity with aromatic amine obtained by hydrolysis of aromatic ketimine (B) with moisture is favorable as mentioned below.

Also, the molecular weight, skeleton, and the like of the polyol compound which produces such a urethane prepolymer are not particularly limited so long as the compound has two or more hydroxyl groups. Specific examples of such a polyol compound include polyether polyol, polyester polyol, other polyol, and mixed polyol thereof. Of those polyol compounds, the case of using at least polyether polyol, i.e., the case where polyol having a polyether skeleton is present in the urethane prepolymer is preferable because a viscosity of the resin composition before curing and an elasticity of the cured compound are excellent.

Specific examples of the polyether polyol include: polyols which are obtained by adding at least one selected from polyalcohols such as ethylene glycol, diethylene glycol, propylene glycol, dipropylene glycol, glycerin, 1,1,1-trimethylol propane, 1,2,5-hexanetriol, 1,3-butanediol, 1,4-butanediol, 4,4-dihydroxyphenylpropane, 4,4′-dihydroxyphenylmethane, and pentaerythritol to the polymer of at least one selected from ethylene oxide, propylene oxide, butylene oxide, styrene oxide, and the like; and polyoxy tetramethyleneoxides.

Specific examples of the polyester polyol include: condensation polymers each containing one or two or more of ethylene glycol, propylene glycol, butanediol, pentanediol, hexanediol, cyclohexane dimethanol, glycerin, 1,1,1-trimethylol propane, and other low molecular polyols, and one or two or more of glutaric acid, adipic acid, pimelic acid, suberic acid, sebacic acid, terephthalic acid, isophthalic acid, dimer acid, and other low molecular carboxylic acids and oligomer acids; and ring opening polymers of cyclic ethers such as propionelactone and valerolactone.

Specific examples of the other polyols include: polymer polyols; polycarbonate polyols; polybutadiene polyols; hydrogenated polybutadiene polyols; acrylpolyols; and low molecular polyols such as ethylene glycol, diethylene glycol, propylene glycol, dipropylene glycol, butanediol, pentanediol, and hexanediol.

Aromatic Ketimine (B)

The aromatic ketimine (B) used for the curable resin composition of the present invention is a compound having a ketimine bond (C═N) obtained by reacting aromatic amine having an amino group directly bound to an aromatic ring with cyclic ketone.

Aromatic amine which produces such aromatic ketimine (B) is not particularly limited so long as the aromatic amine is a compound having an amino group directly bound to the aromatic ring. The aromatic amine is preferably a compound having a structure represented by the following general formula (1), i.e., a trialkylbenzenediamine derivative because the compound is liquid at room temperature and is excellent in working property.

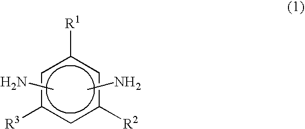

In the formula, R¹, R², and R³ each represent an alkyl group with 1 to 4 carbon atoms which may be branched. Each of the alkyl groups may contain an oxygen atom or sulfur atom. R¹, R², and R³ may identical to or different from one another.

Specific examples of the trialkylbenzenediamine derivative having a structure represented by the general formula (1) include 3,5-diethyl-2,6-diaminotoluene, 3,5-dimethylthio-2,6-diaminotoluene, 1,3,5-trimethyl-2,4-diaminobenzene, 1-methyl-3,5-diethyl-2,4-diaminobenzene, and 1-methyl-3,5-diethyl-2,6-diaminobenzene. Particularly preferable examples thereof include 3,5-diethyl-2,6-diaminotoluene and 3,5-dimethyl-2,6-diaminotoluene.

Further, cyclic ketone, which is a raw material of those aromatic ketimine (B) is ketone having a carbon atom of a carbonyl group as a member of a ring. Specific examples thereof include cyclohexanone, methylcyclohexanone, dimethylcyclohexanone, cyclopentanone, and cycloheptanone. Particularly preferable examples thereof include cyclohexanone, methylcyclohexanone, and cyclopentanone.

The use of such cyclic ketone for the production of aromatic ketimine (B) is preferable compared to the case of using aliphatic ketone because a dehydrating/condensing reaction mentioned below easily proceed, it is easy to accomplish ketimine formation rate of 95% or more and stable, and further dissociation of the obtained aromatic ketimine (B), i.e., the production of aromatic amine by hydrolysis of the aromatic ketimine easily proceeds.

In general, the dehydrating/condensing reaction to produce ketimine by reacting ketone with amine [forming reaction of a ketimine bond (C═N)] is an equilibrium reaction. Thus, the reaction is carried forward by heating/refluxing with eliminating dissociated water by azeotropy in the absence of a solvent or in the presence of a solvent such as benzene, toluene, or xylene, and the aromatic ketimine of the present invention is also produced by means of this general method.

With regard to a mix amount of the aromatic amine and the cyclic ketone, it is preferred that a carbonyl group of the cyclic ketone range from 1.0 to 2.0 time equivalent, and particularly from 1.05 to 1.3 time equivalent based on amino groups of the aromatic amine. It is preferred that the mix amount of the aromatic amine and the cyclic ketone be in the range, because no amino group remains in the aromatic ketimine (B), a dehydrating/condensing reaction time is short, and further an unreacted amount of the cyclic ketone is relatively low, which is not economically disadvantageous. A method of measuring the ketimine formation rate is described below.

Preferable examples of the aromatic ketimine (B) obtained by reacting the aromatic amine with the cyclic ketone include: one obtained by reacting 3,5-diethyl-2,6-diaminotoluene with cyclohexanone [following formula (3)]; one obtained by reacting 3,5-diethyl-2,6-diaminotoluene with methyl cyclohexanone [following formula (4)]; one obtained by reacting 3,5-dimethylthio-2,6-diaminotoluene with cyclohexanone [following formula (5)]; one obtained by reacting 3,5-diethyl-2,6-diaminotoluene with cyclopentanone [following formula (6)] or 3,5-dimethylthio-2,6-diaminotoluene with cyclopentanone[following formula (7)].

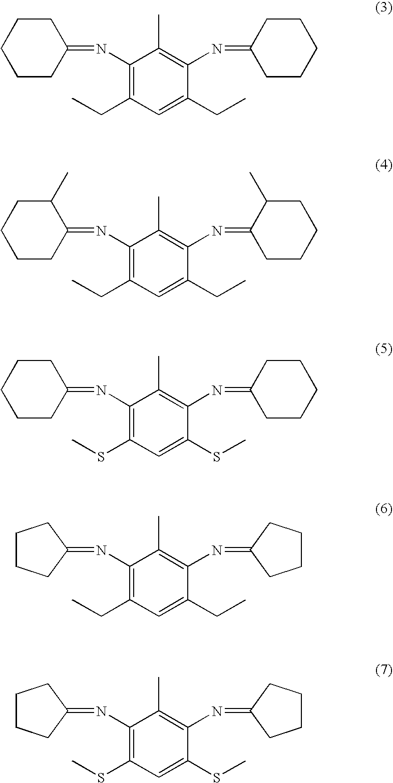

The curable resin composition of the present invention is a composition containing the isocyanate compound (A) and the aromatic ketimine (B). The curable resin composition contains the aromatic ketimine such that an equivalent ratio represented by [isocyanate groups in the isocyanate compound (A)]/[ketimine bonds (C═N) in the aromatic ketimine (B)] ranges preferably from 0.01 to 1.5, and more preferably from 0.2 to 1.2.

The curable resin composition of the present invention may be used as the one-liquid type which cures with moisture in air at the use, or can be used as the two-liquid type where water is added at the use. When used as the one-liquid type, the storage stability and the curability are compatible, and when used as the two-liquid type, the curable resin composition becomes the composition where the working life is appropriately long and the working property is excellent because no increase of the viscosity is caused by the mixture of two liquids.

It is believed that this is because basicity of an imine moiety of the aromatic ketimine (B) is widely weakened to make the storage stability favorable by a steric hindrance effect due to a ring structure derived from cyclic ketone of the aromatic ketimine (B) and by a stabilization effect due to an aromatic ring, and further the aromatic ketimine (B) is easily hydrolyzed by contact with the moisture in air at the use to produce active aromatic amine.

Also in the case of using the curable resin composition as the two-liquid type where the isocyanate compound (A) and the aromatic ketimine (B) are separately stored and water is added at the use, it is believed that the working property is favorable because amino groups only at 5% or less are present in the aromatic ketimine (B) and there is no thickening due to the mixture of two liquids at an initial stage of the use (mixture), and further because of the use of cyclic ketone, the production of aromatic amine by hydrolysis of the aromatic ketimine (B) is easily carried forward and the appropriate working life (about 30 minutes to 2 hours, preferably about 30 minutes to one hour) is obtained.

It is preferred that the curable resin composition of the present invention further contain an acid catalyst (C) in addition to the aforementioned isocyanate compound (A) and aromatic ketimine (B). This is because it is possible to more easily carry forward the hydrolysis of the above aromatic ketimine (B) when the composition contains the acid catalyst (C).

The acid catalyst (C) is not particularly limited so long as it is at least one of organic acids and inorganic acids. Examples of the organic acids include: acetic acid; formic acid; paratoluene sulfonic acid; acidic phosphates represented by the following general formula (8); and blocked acidic phosphates where hydroxyl groups of the acidic phosphates are blocked with silyl compounds (e.g., a trimethylsilyl group). Of those, it I s preferable to use blocked acidic phosphates because they have high storage stability of the composition. Example of the inorganic acids include phosphoric acid, phosphorous acid, and sulfuric acid.

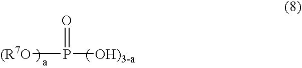

In the formula, a represents an integer of 1 or 2, and R⁷ represents an alkyl group with 1 to 10 carbon atoms which may be branched. Multiple R⁷ may be identical to or different from each other.

Specific examples of the acidic phosphates include methyl acid phosphate, dimethyl acid phosphate, ethyl acid phosphate, diethyl acid phosphate, propyl acid phosphate, isopropyl acid phosphate, dipropyl acid phosphate, monobutyl acid phosphate, dibutyl acid phosphate, dibutyl phosphate, 2-ethylhexyl acid phosphate, bis(2-ethylhexyl)phosphate, isodecyl acid phosphate, monoisodecyl phosphate, butyl pyrophosphate, butoxyethyl acid phosphate, oleyl acid phosphate, tetracosyl acid phosphate, ethylene glycol acid phosphate, and (2-hydroxyethyl)methacrylate acid phosphate. Preferable examples thereof include (2-ethylhexyl) phosphate, 2-ethylhexyl acid phosphate, dibutyl acid phosphate, oleyl acid phosphate, and those obtained by blocking them with hexamethyldisilazane.

A content of the acid catalyst (C) ranges preferably from 0.02 to 5.0 parts by mass, and more preferably from 0.05 to 3.0 parts by mass based on 100 parts by mass of the isocyanate compound (A).

The curable resin composition of the present invention may contain various kinds of additives so far as the effects of the present invention are not damaged. Such additives include a filler, plasticizer, silane-coupling agent, thixotropy imparting agent, pigment, anti-aging agent, antioxidant, antistatic agent, flame retardant, tackifier, dispersant, and solvent.

The filler may either of organic filler or inorganic filler of various form. Specific examples thereof include: calcium carbonate; fumed silica; calcined silica; precipitated silica; ground silica; molten silica diatomaceous earth; iron oxide; zinc oxide; titanium oxide; barium oxide; magnesium oxide; magnesium carbonate; zinc carbonate; agalmatolite; kaolin clay; calcined clay; carbon black; and products obtained by treating them with a fatty acid, resin acid, fatty acid ester, and urethane compound.

Specific examples of the plasticizer include dioctyl phthalate (DOP), dibutyl phthalate (DBP), diisononyl phthalate (DINP), dioctyl adipate, diisodecyl succinate, diethylene glycol dibenzoate, pentaerythritol ester, butyl oleate, methyl acetyl ricinoleate, tricresyl phosphate, trioctyl phosphate, propylene glycol adipate polyester, and butylene glycol adipate polyester. They may be used singly or as a mixture of two or more thereof.

Trimethoxyvinylsilane and γ-glycidoxypropyl trimethoxysilane are suitably exemplified as the silane coupling agent because they are excellent particularly in effect of enhancing adhesiveness to a wet face and further they are compounds commonly used.

Specific examples of the thixotropy imparting agent include fumed silica (“Aerosil” supplied from Nippon Aerosil Co., Ltd.) and activated amide paste (“Disparlon series”, supplied from Kusumoto Chemicals Ltd.).

Specific examples of the pigment include: inorganic pigments such as titanium oxide, zinc oxide, ultramarine blue, blood red, charlton white, and oxides, hydrochlorides, and sulfates of lead, cadmium, iron, cobalt, and aluminum; and organic pigments such as azo pigments, phthalocyanine pigments, quinacridone pigments, quinacridonequinone pigments, dioxazine pigments, anthrapyrimidine pigments, anthanthrone pigments, indanthrone pigments, flavanthrone pigments, perylene pigments, perynone pigments, diketopyrrolo pyrrole pigments, quinonaphthalone pigments, anthraquinone pigments, thioindigo pigments, benzimidazolone pigments, isoindolinone pigments, and carbon black.

Examples of the anti-aging agent include hindered phenol-based compounds and hindered amine-based compounds.

Examples of the antioxidant include butyl hydroxytoluene (BHT) and butyl hydroxyanisole (BHA).

Examples of the antistatic agent include: quaternary ammonium salts; and hydrophilic compounds such as polyglycol and ethylene oxide derivatives.

Examples of the flame retardant include chloroalkyl phosphate, dimethyl/methyl phosphonate, ammonium polyphosphate, neopentyl bromide-polyether, and brominated polyether.

Examples of the tackifier include a terpene resin, phenol resin, terpene-phenol resin, rosin resin, and xylene resin.

The curable resin composition of the present invention can be suitably used for the intended use of adhesive agents, sealing agents, and the like in the fields of painting compound, civil engineering, and construction in both cases of the one-liquid and two-liquid types. In the case of two-liquid type, applicable subjects thereof are in a wider range than those of general curable resin compositions because the working life can be prolonged and the working property is favorable.

Next, the present invention is specifically described by way of examples, but the present invention is not limited to these examples.

Synthesis of Isocyanate Compound (A)

TMXDI urethane prepolymer (a1) and IPDI urethane prepolymer (a2) were synthesized as isocyanate compounds by means of the following respective methods.

TMXDI Urethane Prepolymer (a1)

TMXDI urethane prepolymer (a1) was yielded by: mixing a polyol compound, which is obtained by mixing 750 g of trifunctional polypropylene glycol (PPG) (“Excenol” 5030 supplied from Asahi Glass Co., Ltd., molecular weight 5,000) with 250 g of bifunctional polypropylene glycol (PPG) (“Excenol” 3020 supplied from Asahi Glass Co., Ltd., molecular weight 3,000), with tetramethylxylylene diisocyanate (TMXDI, supplied from Nihon Cytec Industries Inc.) at an equivalent ratio of NCO/OH=2.0; and reacting the mixture with stirring in the presence of a tin catalyst in nitrogen gas flow at 80° C. for 8 hours. The resultant prepolymer (a1) contained 2.1% by mass of isocyanate groups.

IPDI Urethane Prepolymer (a2)

IPDI urethane prepolymer (a2) was yielded by: mixing a polyol compound, which is obtained by mixing 750 g of trifunctional PPG (“Excenol” 5030 supplied from Asahi Glass Co., Ltd., molecular weight 5,000) with 250 g of bifunctional PPG (“Excenol” 3020 supplied from Asahi Glass Co., Ltd., molecular weight 3,000), with isophorone diisocyanate (IPDI, supplied from Degussa Japan) at an equivalent ratio of NCO/OH=2.0; and reacting the mixture with stirring in the presence of a tin catalyst in nitrogen gas flow at 80° C. for 8 hours. The resultant prepolymer (a2) contained 2.1% by mass of isocyanate groups.

Synthesis of Aromatic Ketimine (B)

Aromatic ketimine (b1) to (b3), (b5), and (b6) represented by the formulae (3) to (7) were synthesized as aromatic ketimine (B) by means of the following respective methods. Also, aliphatic ketimine (b4) was synthesized by means of the following method.

Aromatic Ketimine (b1)

Aromatic ketimine (b1) was yielded by: mixing 178 g of 3,5-diethyl-2,6-diaminotoluene (“Epikure” W, supplied from Japan Epoxy Resins Co., Ltd.) with 216 g of cyclohexanone which corresponded to 1.1 time equivalent of the amino groups in the diamine in 300 g of toluene; and reacting the mixture for 10 hours with heating/refluxing at a temperature of 150° C. while eliminating dissociated water through azeotropy. After the completion of the reaction (after confirmation of the production of water at a theoretical amount), toluene and excessive cyclohexanone were distilled off under reduced pressure to yield the objective ketimine. Since the amount of produced water was 36 g which was the theoretical amount, it was determined that a ketimine formation rate was 100%.

Aromatic Ketimine (b2)

Aromatic ketimine (b2) was yielded by: mixing 178 g of 3,5-diethyl-2,6-diaminotoluene (“Epikure” W, supplied from Japan Epoxy Resins Co., Ltd.) with 246 g of methylcyclohexanone which corresponded to 1.1 time equivalent of the amino groups in the diamine in 300 g of toluene; and reacting the mixture for 40 hours with heating/refluxing at a temperature of 150° C. while eliminating dissociated water through azeotropy. After the completion of the reaction (after confirmation of the production of water at a theoretical amount), toluene and excessive methylcyclohexanone were distilled off under reduced pressure to yield the objective ketimine. Since the amount of produced water was 36 g which was the theoretical amount, it was determined that a ketimine formation rate was 100%.

Aromatic Ketimine (b3)

Aromatic ketimine (b3) was yielded by: mixing 214 g of 3,5-diethylthio-2,6-diaminotoluene (“Etakure” 300, supplied from Albemarle) with 246 g of methylcyclohexanone which corresponded to 1.1 time equivalent of the amino groups in the diamine in 300 g of toluene; and reacting the mixture for 15 hours with heating/refluxing at a temperature of 150° C. while eliminating dissociated water through azeotropy. After the completion of the reaction (after confirmation of the production of water at a theoretical amount), toluene and excessive cyclohexanone were distilled off under reduced pressure to yield the objective ketimine. Since the amount of produced water was 36 g which was the theoretical amount, it was determined that a ketimine formation rate was 100%.

Aliphatic Ketimine (b4)

Aliphatic ketimine (b4) represented by the following formula (9) was yielded by: mixing 142 g of 1,3-bisaminomethylcyclohexane (1,3-BAC, supplied from Mitsubishi Chemical Corporation) with 206 g of methyl isopropyl ketone which corresponded to 1.2 time equivalent of the amino groups in the diamine in 100 g of toluene; and reacting the mixture for 15 hours with heating/refluxing at a temperature of 150° C. while eliminating dissociated water through azeotropy. After the completion of the reaction (after confirmation of the production of water at a theoretical amount), toluene and excessive cyclohexanone were distilled off under reduced pressure to yield the objective ketimine. Since the amount of produced water was 36 g which was the theoretical amount, it was determined that a ketimine formation rate was 100%. 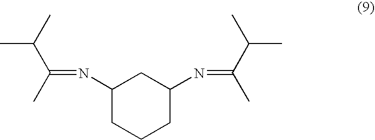
Aromatic ketimine (b5)>

Aromatic ketimine (b5) was yielded by: mixing 178 g of 3,5-diethyl-2,6-diaminotoluene (“Epikure” W, supplied from Japan Epoxy Resins Co., Ltd.) with 220 g of methyl isobutyl ketone which corresponded to 1.1 time equivalent of the amino groups in the diamine in 300 g of toluene; and reacting the mixture for 3 days with heating/refluxing at a temperature of 150° C. in the presence of 0.2 g of paratoluene sulfonic acid while eliminating dissociated water through azeotropy. After the completion of the reaction (after confirmation of the production of water at a theoretical amount), toluene and excessive cyclohexanone were distilled off under reduced pressure to yield the objective ketimine. Since the amount of produced water was 36 g which was the theoretical amount, it was determined that a ketimine formation rate was 100%.

Aromatic ketimine (b6)

Aromatic ketimine (b6) was yielded by: mixing 138 g of 3,5-diethyl-2,6-diaminotoluene (“Epikure” W, supplied from Japan Epoxy Resins Co., Ltd.) with 138 g of cyclopentanone which corresponded to 0.7 time equivalent of the amino groups in the diamine in 300 g of toluene; subjecting the mixture to heating/refluxing at a temperature of 150° C. while eliminating dissociated water through azeotropy; and distilling toluene and cyclohexanone under reduced pressure when the amount of produced water reached 25.2 g which corresponded to 70% in terms of amine equivalent.

Aromatic Ketimine (b7)

Aromatic ketimine (b7) was yielded by: mixing 178 g of 3,5-diethyl-2,6-diaminotoluene (“Epikure” W, supplied from Japan Epoxy Resins Co., Ltd.) with 138 g of cyclopentanone which corresponded to 1.1 time equivalent of the amino groups in the diamine in 300 g of toluene; and reacting the mixture for 10 hours with heating/refluxing at a temperature of 150° C. while eliminating dissociated water through azeotropy. After the completion of the reaction (after confirmation of the production of water at a theoretical amount), toluene and excessive cyclopentanone were distilled off under reduced pressure to yield the objective ketimine. Since the amount of produced water was 36 g which was the theoretical amount, it was determined that a ketimine formation rate was 100%.

Aromatic Ketimine (b8)

Aromatic ketimine (b8) was yielded by: mixing 214 g of 3,5-diethylthio-2,6-diaminotoluene (“Etakure” 300, supplied from Japan Epoxy Resins Co., Ltd.) with 185 g of cyclopentanone which corresponded to 1.1 time equivalent of the amino groups in the diamine in 300 g of toluene; and reacting the mixture for 15 hours with heating/refluxing at a temperature of 150° C. while eliminating dissociated water through azeotropy. After the completion of the reaction (after confirmation of the production of water at a theoretical amount), toluene and excessive cyclopentanone were distilled off under reduced pressure to yield the objective ketimine. Since the amount of produced water was 36 g which was the theoretical amount, it was determined that a ketimine formation rate was 100%.

### Examples 1 to 7, COMPARATIVE EXAMPLES 1 to 4

Each composition was manufactured by combining aromatic ketimine (b1) to (b3), (b5), or (B6) which was the aromatic ketimine (B), aliphatic ketimine (b4), acidic phosphate (c1), block acidic phosphate (c2), or paratoluene sulfonic acid (c3) which was an acid catalyst (C), and a plasticizer at composition components (parts by mass) shown in the following Table 1 based on 100 parts by mass of TMXDI urethane prepolymer (a1) or IPDI urethane prepolymer (a2) which was an isocyanate compound (A). Each of the resultant compositions were evaluated for storage stability and tack free time shown below. The results are shown in the following Table 1.

Those shown below were used as the above composition components.

Acidic phosphate (c1): bis(2-ethylhexyl)phosphate (LB-58, supplied from Johoku Chemical Co., Ltd.)

Block acidic phosphate (c2): yielded by: dripping 30 g of hexamethyldisilazane (HMDS) to 100 g of bis(2-ethylhexyl)phosphate (LB-58, supplied from Johoku Chemical Co., Ltd.); reacting the mixture at room temperature for 30 minutes and at 60° C. for one hour with heating/stirring; and eliminating ammonia and excessive HMDS under reduced pressure.

Plasticizer: diisononyl phthalate (DINP, supplied from New Japan Chemical Co., Ltd.).

The resultant curable resin compositions were evaluated by means of the methods described below.

Storage stability test (70° C. One Day Viscosity Increasing Rate)

The viscosity of each of the resultant compositions was measured immediately after the preparation (initial stage) and after aging at 70° C. for one day, and a thickening rate of each composition was examined. When the viscosity increasing rate was twice or less, facilitation stability was favorable, and thus the composition was evaluated to be excellent in storage stability.

Tack Free Time (TFT)

Each of the resultant compositions was cured under a condition of 20° C. and 60% RH, and a tack free time was measured in reference to JIS A5758 (sealing material for construction). When the tack free time was 24 hours or less, the composition was evaluated to be excellent in curability.

TABLE 1

| | Compara- | Compara- | | | | | | | | Compara- | Compara- |
|---|---|---|---|---|---|---|---|---|---|---|---|
| | tive | tive | Exam- | Exam- | Exam- | Exam- | Exam- | Exam- | Exam- | tive | tive |
| | Example 1 | Example 2 | ple 1 | ple 2 | ple 3 | ple 4 | ple 5 | ple 6 | ple 7 | Example 3 | Example 4 |
| Isocyanate compound (A) | | | | | | | | | | | |
| TMXDI urethane prepolymer (al) | 100 | | 100 | 100 | 100 | 100 | | 100 | 100 | | 100 |
| IPDI urethane prepolymer (a2) | | 100 | | | | | 100 | | | 100 | |
| Aromatic ketimine (B) | | | | | | | | | | | |
| (Ketimine formation rate) | | | | | | | | | | | |
| Aromatic ketimine (b1) (100%) | | | 9.2 | 9.2 | | | | | | | |
| Aromatic ketimine (b2) (100%) | | | | | 9.9 | | | | | | |
| Aromatic ketimine (b3) (100%) | | | | | | 10.3 | 10.5 | | | | |
| Aromatic ketimine (b5) (100%) | | | | | | | | | | 8.2 | |
| Aromatic ketimine (b6) (70%) | | | | | | | | | | | 7.9 |
| Aromatic ketimine (b7) (100%) | | | | | | | | 8.4 | | | |
| Aromatic ketimine (b8) (100%) | | | | | | | | | 9.4 | | |
| Aliphatic ketimine | | | | | | | | | | | |
| (Ketimine formation rate) | | | | | | | | | | | |
| Aliphatic ketimine (b4) (100%) | 7.6 | | | | | | | | | | |
| Acid catalyst (C) | | | | | | | | | | | |
| Acidic phosphate (c1) | | | 0.3 | | 0.5 | 0.5 | | | | 0.3 | 0.3 |
| Block phosphate (c2) | | | | 0.4 | | | 0.4 | 0.4 | 0.4 | | |
| Plasticizer | 50 | 50 | 50 | 50 | 50 | 50 | 50 | 50 | 50 | 50 | 50 |
| Viscosity increasing rate (Times) | 2.6 | 1.0 | 1.6 | 1.4 | 1.4 | 1.3 | 1.8 | 1.5 | 1.4 | 1.6 | 5.0 |
| TFT (hours) | 4 | 60 | 8 | 8 | 18 | 12 | 4 | 7 | 10 | 30 | 6 |

The results shown in Table 1 reveal that the compositions shown in Examples 1 to 7 are excellent in storage stability because a viscosity increase is small. Also, it has been found that excellent results are shown for the tack free time. Thus, it has become obvious that the storage stability and the curability are compatible.

According to the present invention, it is possible to provide the curable resin composition where the storage stability and the curability are compatible when the composition is used as the one-liquid type, and to provide the curable resin composition where the working life is appropriately long and the working property is excellent because no thickening is caused by the mixture of two liquids when the composition is used as the two-liquid type. Such curable resin compositions of the present invention are useful as adhesive agents, sealing agents, joint fillers, and the like in the fields of painting compound, civil engineering, and construction.

1. A curable resin composition, comprising an isocyanate compound (A) and aromatic ketimine (B) obtained by reacting aromatic amine having an amino group directly bound to an aromatic ring with cyclic ketone.

2. The curable resin composition according to claim 1 wherein the isocyanate compound (A) comprises a urethane prepolymer obtained by reacting a diisocyanate compound where all isocyanate groups in a molecule are bound to aliphatic or alicyclic secondary carbon or tertiary carbon with a polyol compound.

3. The curable resin composition according to claim 1 wherein the cyclic ketone which is reacted with the aromatic amine comprises ketone where carbon of a carbonyl group is a member of a ring.

4. The curable resin composition according to claim 1 or 3 wherein the aromatic amine comprises a trialkylbenzenediamine derivative represented by the following general formula (1): 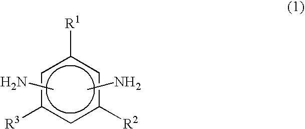
Wherein R¹, R², and R³ each represent an alkyl group with 1 to 4 carbon atoms which may be branched, each of the alkyl groups may contain one of an oxygen atom and a sulfur atom, and R¹, R², and R³ may be identical to or different from one another.

5. The curable resin composition according to claim 1 or 3 wherein a ketimine formation rate of the aromatic amine is 95% or more.

6. The curable resin composition according to claim 1 or 3 wherein the aromatic ketimine (B) is obtained by one of: a reaction of 3,5-diethyl-2,6-diaminotoluene with one of cyclohexanone and cyclopentanone; a reaction of 3,5-diethyl-2,6-diaminotoluene with one of methylcyclohexanone; and a reaction of 3,5-dimethylthio-2,6-diaminotoluene with one of cyclohexanone and cyclopentanone.

7. The curable resin composition according to claim 1 or 3 wherein a mix ratio of the aromatic ketimine (B) and the isocyanate compound (A) ranges from 0.01 to 1.5 at an equivalent ratio represented by [NCO groups in the isocyanate compound (A)]/[ketimine bonds (C═N) in the aromatic ketimine(B)].

8. The curable resin composition according to claim 1 or 3, further comprising an acid catalyst (C).

9. The curable resin composition according to claim 1 or 3 wherein the acid catalyst (C) comprises one of an acidic phosphate and a block acidic phosphate.
